(19) United States
(12) Patent Application Publication
(10) Pub. No.: US 2003/0199260 A1
(43) Pub. Date: Oct. 23, 2003

(54) Wireless communication receiver and method for determining a reference frequency in a wireless communication device

(76) Inventors: Francis M. Casey, Chandler, AZ (US); Russell D. Thomas, Chandler, AZ (US); Mark A. Heng, Scottsdale, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/126,852

(22) Filed: Apr. 19, 2002

(51) Int. Cl. H04B 1/00

(52) U.S. Cl. 455/150.1; 455/151.3

(57) ABSTRACT

A method of determining a reference frequency in a wireless communication device is disclosed. The method comprises the steps of providing a known frequency source; receiving a signal from an unknown frequency source; and calculating an estimate of the frequency of the signal from the unknown frequency source based upon the frequency of the known frequency source. establishing a communication link based upon the frequency of the signal from the unknown frequency source. A wireless communication device according to the present invention is also disclosed comprising a first frequency source associated with a GPS receiver and generating a substantially fixed frequency; a second frequency source associated with a host device and generating an unknown frequency; a counter coupled to the second frequency source; and a control circuit coupled to the counter, the control circuit determining the frequency of the second frequency source based upon the substantially fixed frequency and a value of the counter.

### FIELD OF THE INVENTION

This invention relates generally to communication systems, and in particular, to a wireless communication receiver and a method for determining an external reference frequency for use in a wireless communication device.

### BACKGROUND OF THE INVENTION

As wireless communication networks continue to advance, new applications for wireless technology continue to be developed. The Global Positioning System (GPS), which generally enables the determination of location information, had been limited by Selective Availability (SA), which is the intentional degradation of the standard positioning service (SPS) signals by a time varying bias. SA is controlled by the United States Department of Defense and was used to limit accuracy for non-U.S. military and government users. Although there were ways to overcome SA and provide accurate location information, such GPS receivers capable of providing accurate location information were often expensive. However, on May 1, 2000, SA was turned off, enabling highly accurate GPS receivers at a significantly lower cost.

Further, recent regulations enacted by the Federal Communications Commission (FCC) have created a new market for GPS receivers. For example, recent requirements by the FCC have required that cellular telephones provide location information to a degree of accuracy that could be provided by GPS.

Another application for GPS receivers can be found in the area of telematics. Telematics is a term generally related to the provisioning of data and/or services to vehicles. One particularly beneficial aspect of a telematics system is the transmission of location information related to a vehicle in the event of an emergency condition. For example, if a vehicle is in an accident and an air bag is deployed, the telematics unit in the vehicle will automatically contact a public safety answering point (PSAP) and transfer information such as the location of the device or information related to the status of vehicle systems.

Due to advances in technology and reduction in cost, GPS receivers are also finding wide spread acceptance as accessory functions for many portable devices (i.e. host devices) such as wrist watches, cell phones, radios, and Personal Digital Assistance (PDA) devices. The GPS receivers could be coupled to the host devices, such as by a cable, or could be integrally incorporated in the host device, such as a GPS chip in a cellular telephone. Many of these new platforms or host devices contain their own internal reference frequency source that typically varies in frequency range dependent upon internal host requirements. These types of devices in general use uncompensated crystal controlled oscillators to generate their reference frequency. These types of reference sources generally have a wide range of frequency uncertainty, usually 30 to 40 parts per million.

In order to accommodate a wide range of host devices, GPS receivers are becoming more autonomous. The current GPS receiver technology is converging on a single chip solution. Further, current GPS receivers are designed to accept a wide range of external reference frequencies. However, knowledge of the reference frequency must be provided to the GPS receiver before it can establish a proper communication link (i) between the GPS receiver and the GPS satellites in a timely manner or (ii) between the GPS receiver and host device using synchronous or asynchronous communication Programming the reference frequencies into products at the time of manufacture can significantly increase manufacturing costs.

Accordingly, there is a need for an improved wireless communication receiver and a method for determining an external reference frequency to be used by the wireless communication device.

### BRIEF DESCRIPTION OF THE DRAWINGS

FIG. 1 is a block diagram of a wireless communication system according to the present invention;

FIG. 2 is a block diagram of a telematics communication unit according to the present invention;

FIG. 3 is a block diagram of a wireless communication receiver according to the present invention;

FIG. 4 is a block diagram of a wireless communication receiver according to an alternate embodiment of the present invention;

FIG. 5 is a flow chart showing a method of determining a reference frequency on a wireless communication device according to the present invention;

FIG. 6 is a flow chart showing a more detailed method for determining a reference frequency in a wireless communication device according to the present invention; and

FIG. 7 is a flow chart showing a method for establishing an asynchronous communication interface to a host based on determining a reference frequency in a wireless communication device according to the present invention.

### DESCRIPTION OF THE PREFERRED EMBODIMENTS

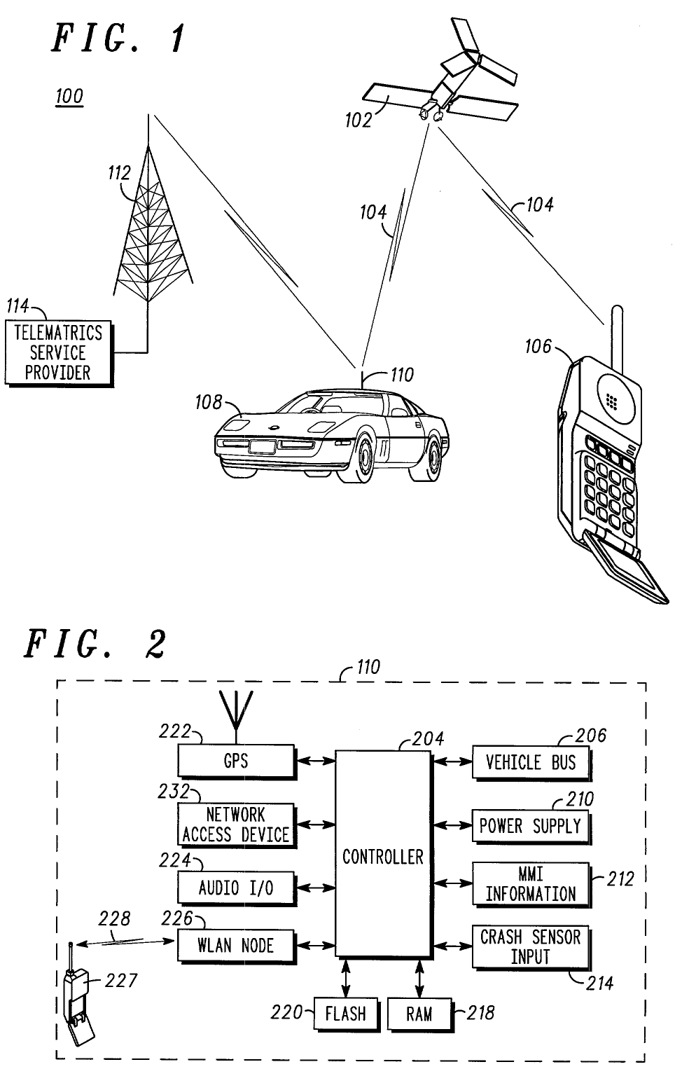

Turning now to FIG. 1, a wireless communication network 100 according to the present invention is shown. In particular, a satellite 102 provides satellite communication signals 104 to a wireless communication device 106 or a vehicle 108 by way of a telematics communication unit 110. The wireless communication device 106 or the telematics communications unit 110 could be a host device for wireless communication receiver, such as a GPS receiver according to the present invention. The satellite 102 could be any communication satellite, such as a satellite for the global positioning system (GPS), which is well known in the art. The wireless communication device 106 could be any communication device adapted to receive wireless communication signals, such as a portable GPS receiver, or any device incorporating a GPS receiver. The telematics communication unit 110 preferably is adapted to communicate with another wireless communication network 112, such as a cellular communication network, coupled to a telematics service provider 114.

Turning now to FIG. 2, a block diagram of the telematics communication unit 110 according to the present invention which could be installed in the vehicle 108 of FIG. 1 is shown. The telematics communication unit 110 preferably comprises a controller 204 having various input/output (I/O) ports for communicating with various components of a vehicle. For example, the controller 204 is coupled to a vehicle bus 206, a power supply 210, a man machine interface (MMI) 212, and a crash sensor input 214. The connection to the vehicle bus enables operations such as unlocking the door, sounding the horn, flashing the lights, etc. The controller 204 is also preferably coupled to various memory elements, such as a random access memory (RAM) 218 or a flash memory 220. The telematics controller 204 also preferably includes a global positioning system (GPS) unit 222 which provides the location of the vehicle, as is well known in the art. The telematics controller 204 is also preferably coupled to an audio I/O 224 which preferably includes a hands-free system for audio communication for a user of the vehicle by way of a wireless communication network, such as a cellular telephone network.

Finally, the telematics unit 110 could include a wireless local area network (WLAN) node 226 which is also coupled to the telematics controller 204 and enables communication between a WLAN enabled device such as a wireless communication device 227 and the telematics controller 204 by way of the WLAN node 226. The wireless communication device 227 could communicate with the WLAN enabled telematics control unit 110, and therefore, a network access device 232, by any WLAN protocol, such as Bluetooth, IEEE 802.11, IrdA, or any other WLAN application, on a communication link 228. The communication link 228 preferably provides a local, low power connection between the wireless communication device 227 and a network access device 232 of the vehicle. The network access device 232 could be, for example, a cellular telephone transceiver or other two-way wireless communication device which is well known in the art.

Turning now to FIG. 3, a receiver 302, which could be incorporated in the GPS unit 222 or the wireless communication device 106, is coupled to an antenna 304 and comprises a downconverter 306 coupled to a correlator 308, as is well known in the art. GPS signals are received from GPS satellites, such as the wireless communication signals 104 from the satellite 102 shown in FIG. 1. The correlator 308 is coupled to a microprocessor 310. The microprocessor 310 is coupled to a real time clock (RTC) 312 and a universal asyncronous receiver/transmitter (UART) 314 which communicates with a user system. For example, the UART 314 could communicate with a controller of wireless communication device 106, controller 204 of the telematics communication unit 110, or any other device incorporating the receiver 302.

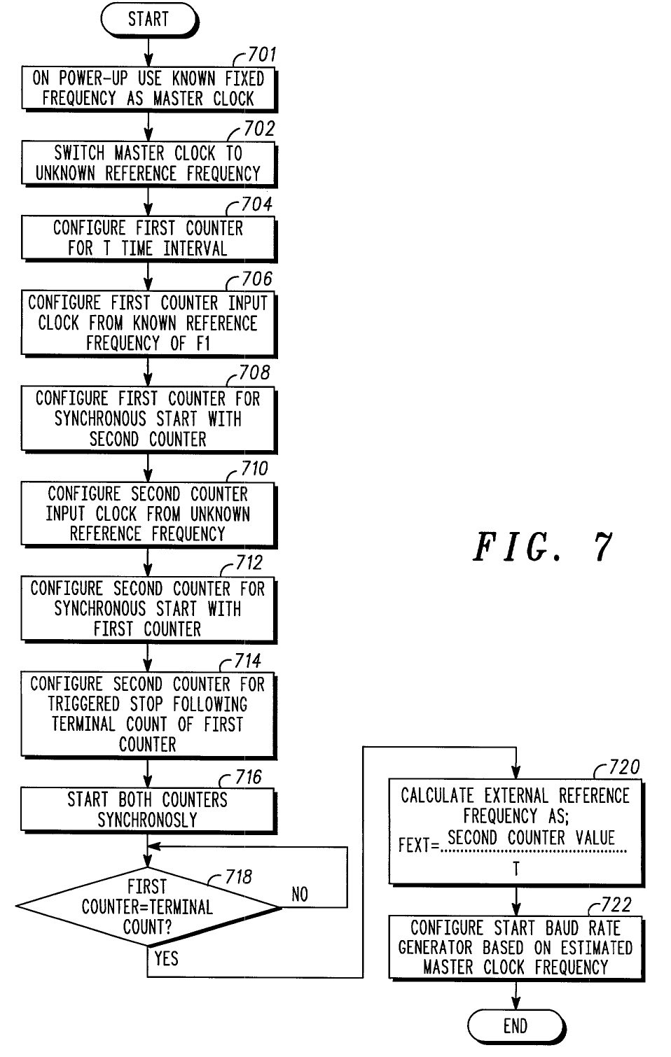

The microprocessor 310 is also coupled to a counter A 316 and a counter B 318. As will be described in more detail in reference to FIG. 7, the counter A 316 is coupled to trigger the counter B 318. The counter A 316 and the RTC 312 are coupled to a known oscillator 317. Similarly, the counter B 318 is coupled to an unknown frequency source, such as an external oscillator 319. The external oscillator 319 could be, for example, a crystal associated with a wireless communication device such as a cellular telephone. Alternatively, the external oscillator 319 could be the reference source of a wide array of host devices such as wrist watches, portable radios, CD players, alarm system remote controls or any other electronic device that requires it's own internal reference frequency source. The external oscillator may also be a dedicated reference source to be used only by the GPS receiver but this dedicated source may vary in nominal frequency value due to availability, cost or other influences. By using an external oscillator of the host device according to the present invention, it is possible to reduce product cost by eliminating the need for an additional oscillator in the wireless communication device. That is, because the external oscillator is already present in the host device, there is no need for an additional oscillator for the wireless communication device.

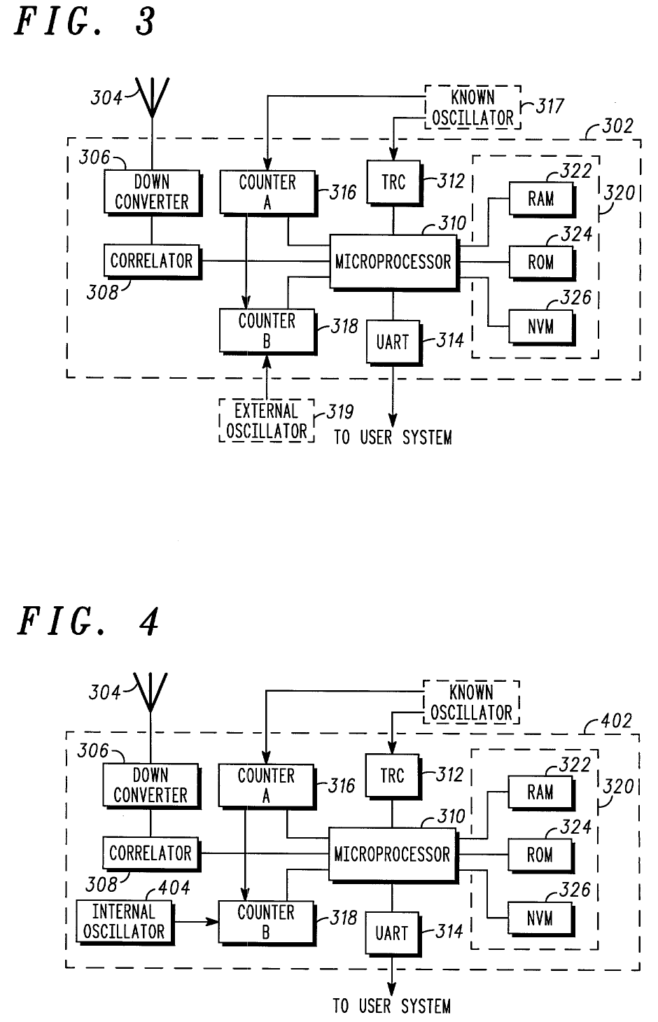

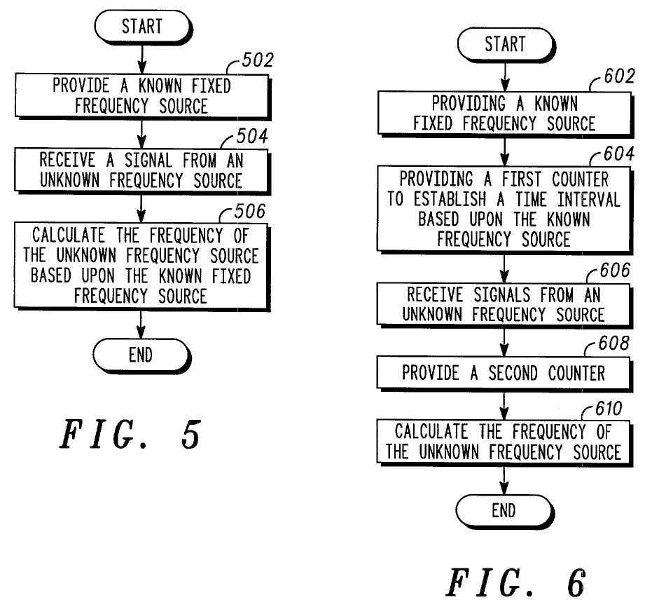

As will be described in more detail in reference to FIGS. 5 through 7, the first counter can be used in conjunction with the known oscillator 317 to establish a time period T, while the second counter could be used to count the cycles of the oscillator during the time period T. Finally, the microprocessor is coupled to a memory portion 320. The memory portion 320 preferably comprises a random access memory (RAM) 322, a read only memory (ROM) 324 and a non-volatile memory (NVM) 326. The elements of receiver 302 could be incorporated on a single integrated circuit (IC), or on multiple IC's. While the known oscillator 317 is shown separate from the receiver 302, the known oscillator 317 could be incorporated on an IC of the receiver 302 as shown in FIG. 4.

Turning now to FIG. 5, a flow chart shows a method of determining a reference frequency in a wireless communication device. A known fixed frequency source, such as the known oscillator 317 of FIGS. 3 and 4, is provided at a step 502. A reference signal from an unknown frequency source is then received at a step 504. The unknown frequency source could be external oscillator 319 of FIG. 3, or internal oscillator 404 of FIG. 4, for example. The frequency of the external frequency source is calculated based upon the frequency of the known oscillator at a step 506. Finally, a communication link is then established at a step 508. The communication link could be a communication link between the wireless communication device, such as a GPS receiver, and a host as described above. For example, the communication link could be used to communicate the necessary baud rate to enable communication between a GPS receiver and a cellular telephone. Alternatively, the communication link could be a wireless communication link between the wireless communication device and a communication network. For example, the wireless communication device could determine the reference frequency of the host without establishing a communication link between the wireless communication link and the host, and establish a communication link between the wireless communication device and a communication network. Finaly, both communication links described above could be established according to the present invention.

Turning now to FIG. 6, a flow chart shows a more detailed method for determining a reference frequency in a wireless communication device according to the present invention. The determination of the reference frequency will have a frequency tolerance that is equivalent to that of the known reference if proper resolution of the counter is observed. To insure a high degree of resolution, two counters are preferably used. In particular, a known fixed frequency source is provided at a step 602. A first counter to establish a time period T based upon the known fixed frequency source is provided at a step 604. The first counter, the counter A 316 for example, could count 32768 cycles of the 32.768 KHz known reference to produce a 1 second time period T.

Signals from an unknown frequency source are received at a step 606 and coupled to a second counter at a step 608. The frequency of the unknown frequency source is calculated at a step 610. For example, the second counter, such as the counter B 318 could count up to 33,000,000 cycles of the unknown reference frequency over the 1 second time period T as defined by counter A to determine the frequency.

The maximum error introduced by this frequency measurement will be ±0.03PPM (±1/33,000,000). This error is added to the fixed frequency reference error to calculate the total amount of frequency error in the estimate of the unknown reference frequency. If the additional error tolerance due to the estimate is allowed to be ±1 PPM, then the time period T counter A can be reduced by a factor of 33 to 993 Hz (32768/33) for a reduced period of 30.3 msec (1/33). The counter B will count up to 1,000,000 cycles of the unknown reference over the 30.3 msec interval as defined by counter A. The frequency measurement of the unknown reference frequency will be less accurate as the known reference by this error tolerance.

Finally, a communication link is established between the wireless communication device and a host at a step 612. Also, a communication link is established between the wireless communication device and a communication network at a step 614. For example, the communication link between the wireless communication device and the host could be used to communicate the necessary baud rate to enable communication between the wireless communication device and the host, while the communication link between the wireless communication device and the network could allow the wireless communication device to receive communication signals, such as GPS signals to establish the location of the wireless communication device. One particular example of a need for the method of FIG. 6 could be found in marine electronic devices. In particular, a GPS receiver could include a host interface that supports the National Marine Electronics Association (NMEA) Standard for Interfacing Marine Electronic Devices. This standard interface is based on a Universal Synchronous/Asynchronous Receiver/Transmitter (USART) communication port that requires a fixed baud rate.

Reference frequencies in the crystal industry vary over a wide range but certain values are more common by host application and production volume. Many of these more common values that are used by the various hosts can be stored in the wireless communication (GPS) receiver's memory such as NVM 326 and used to improve the initial estimate of the unknown reference frequency. For example, many Compact Disc Players use a 16.9344 MHz reference crystal frequency. If the unknown reference frequency calculation above is found to be within a predetermined tolerance of this standard frequency, then the wireless communication (GPS) receiver would use the standard frequency as it's initial unknown frequency estimate.

A more precise frequency measurement of the unknown reference frequency is performed by the wireless communication (GPS) receiver using GPS navigation algorithms to compute the frequency error as part of the normal position fix calculation. This improved frequency information that is calculated could also be stored in non-volatile memory, such as NVM 326, and used for subsequent startup scenarios to reduce the amount of time required to establish a communication link between the GPS receiver and GPS satellites for future sessions. This data could be re-verified at a later point in time when maintenance of the GPS receiver is being performed to verify the validity of the frequency estimate over time and temperature.

Turning now to FIG. 7, a flow chart shows a method for determining a reference frequency in a wireless communication device to establish an external synchronous or asynchronous communication channel between the device and a host according to a further alternate embodiment of the present invention. On power-up the GPS receiver will use a known fixed reference frequency, such as known oscillator 317, to perform the initial boot operation at a step 701. At an appropriate time, the receiver will switch the master clock over to an unknown reference, such as external oscillator 319 or internal oscillator 404 at a step 702 and begin the process of estimating the frequency of the unknown reference.

In particular, a first counter, such as counter A 316, is configured for a time interval T at a step 704. For example, the first counter is configured by loading it with a terminal count value that coincides with the interval period T when clocked by the known reference frequency of 32.768 KHz. The first counter is configured to receive the input clock from a known frequency reference, such as known oscillator 317 of FIGS. 3 and 4.

The first counter is configured to start synchronously with a second counter, such as counter B 318, at a step 708. The second counter is then configured to receive an input clock from the unknown reference frequency at a step 710. The second counter is then configured to start synchronously with the first counter at a step 712. The second counter is triggered to stop following the terminal count of the first counter at a step 714. Both counters are then started synchronously at a step 716. It is then determined whether the first counter has reached the terminal count at a step 718. If the first counter has reached the terminal count, the unknown reference frequency is calculated at a step 720. In particular, the frequency is calculated by dividing the second counter value by the period T. Finally, the USART generator is configured based upon a calculated frequency at a step 722.

In summary, the wireless communication device and method of the present disclosure solves the problem of having to communicate the external reference frequency information to a wireless communication receiver, such as a GPS receiver. The current invention solves the problem by using a separate oscillator reference of a known fixed frequency, and comparing an unknown reference to the known fixed reference to calculate the unknown reference frequency. The known fixed frequency source may be an external crystal or internal oscillator of a GPS receiver that also supports other functions such as a Real Time Clock (RTC). In this particular implementation, the unknown reference frequency may be as high as 33 MHz and the known fixed frequency will be a standard 32.768 KHz crystal used for a Real Time Clock reference in the GPS receiver. It is believed that the solution provides a cost savings and flexible interfacing of a wireless (GPS) communication device with host devices, and also reduces manufacturing costs associated with documenting and programming reference frequencies into products that will use this technology.

It can therefore be appreciated that the new and novel wireless communication receiver and method for determining a reference frequency in a wireless communication device has been described. It will be appreciated by those skilled in the art that, given the teaching herein, numerous alternatives and equivalents will be seen to exist which incorporate the disclosed invention. As a result, the invention is not to be limited by the foregoing embodiments, but only by the following claims.

1. A method of autonomously determining a reference frequency for use in a wireless communication device, said method comprising the steps of:
providing a known frequency source;
receiving a signal from an unknown frequency source; and
calculating an estimate of the frequency of said signal from said unknown frequency source based upon the frequency of said known frequency source.
establishing a communication link based upon the frequency of the signal from said unknown frequency source.

2. The method of claim 1 wherein said step of providing a known frequency source comprises providing an oscillator having a known fixed frequency.

3. The method of claim 1 wherein said step of providing a known frequency source comprises providing an internal oscillator comprising a crystal used for a real time clock reference in said wireless communication device.

4. The method of claim 1 wherein said step of receiving a signal from an unknown frequency source comprises receiving a reference signal from a reference frequency source associated with a host device.

5. The method of claim 1 wherein said step of calculating an estimate of the frequency of said signal from said unknown frequency source comprises comparing said signal from said unknown frequency source to said signal from said known frequency source.

6. The method of claim 1 wherein said step of establishing a communication link comprises establishing a communication link between said wireless communication device and a host device.

7. The method of claim 6 further comprising a step of establishing a communication link between said wireless communication device and a communication network.

8. The method of claim 1 wherein said step of establishing a communication link comprises establishing a communication link between said wireless communication device and a communication network.

9. The method of claim 1 further comprising a step of receiving a satellite communication signal.

10. A method of autonomously determining a reference frequency, said method comprising the steps of:
providing a known fixed frequency source from an internal oscillator in a wireless communication device; receiving a signal from an unknown frequency source associated with a host device;
calculating the frequency of said signal from said unknown frequency source based upon the frequency of said known fixed frequency source; and
establishing a communication link between said wireless communication device and said host device; and
establishing a communication link between said wireless communication device and a communication network.

11. A method of autonomously determining a reference frequency, said method comprising the steps of:
providing a known frequency source associated with a GPS receiver;
receiving a signal from an unknown frequency source associated with a host device at said GPS receiver;
calculating the frequency of said signal from said unknown frequency source based upon the frequency of said known fixed frequency source; and
establishing a communication link between said GPS receiver and said host device.

12. The method of claim 11 wherein said step of providing a known frequency source associated with a GPS receiver comprises providing an internal oscillator having a substantially fixed frequency.

13. The method of claim 12 wherein said step of providing an internal oscillator comprises providing a crystal used as real time clock reference in said GPS receiver.

14. The method of claim 11 wherein said step of providing a known frequency source associated with a GPS receiver comprises providing an external crystal.

15. The method of claim 11 further comprising a step of receiving a GPS communication signal at said GPS receiver from a GPS satellite.

16. The method of claim 11 further comprising a step of setting a first counter as a fixed time interval counter.

17. The method of claim 16 further comprising a step of loading said first counter with a terminal count value based upon a predetermined interval period.

18. The method of claim 17 further comprising a step of using a second counter to count the cycles of said signal from said unknown frequency source based upon said predetermined interval period.

19. The method of claim 18 wherein said step of calculating the frequency of said signal from said unknown frequency source comprises calculating the frequency based upon the count of said second counter and said predetermined interval period.

20. A method of autonomously determining a reference frequency, said method comprising the steps of:
providing a known fixed frequency source associated with a GPS receiver;
using a counter to count the cycles of an unknown frequency source associated with a host device;
calculating the frequency of said unknown frequency source based upon the count of said counter and the frequency of said known fixed frequency source; and
establishing a communication link between said GPS receiver and said host device.

21. A method of autonomously determining a reference frequency, said method comprising the steps of:
providing a known frequency source associated with a GPS receiver;
receiving a signal from an unknown frequency source from a host device at said GPS receiver; and
calculating the frequency of said signal from said unknown frequency source based upon the frequency of said known fixed frequency source; and
establishing a communication link between said wireless communication device and a communication network.

22. The method of claim 21 wherein said step of providing a known fixed frequency associated with a GPS receiver comprises providing a crystal used for real time clock reference in said GPS receiver.

23. The method of claim 21 further comprising a step of using a first counter to count the cycles of said unknown frequency source.

24. The method of claim 23 further comprising a step of using a second counter as a fixed time interval counter for determining a first predetermined period of time.

25. The method of claim 24 further comprising a step of loading said first counter with a terminal count value based upon said first predetermined interval period of time.

26. The method of claim 25 wherein said step of using a first counter to count the cycles of said unknown frequency source comprises counting the cycles of said unknown frequency source during said first predetermined period of time.

27. The method of claim 26 wherein said step of calculating the frequency of said unknown frequency source comprises determining the count of said first counter during said first predetermined period of time.

28. A method of autonomously determining a reference frequency, said method comprising the steps of:
providing a known frequency source associated with a GPS receiver;
using a first counter to determine a predetermined period of time based upon said known frequency source;
coupling an unknown frequency source from a host to said GPS receiver;
using a second counter to count the cycles of said unknown frequency source;
calculating the frequency of said unknown frequency source based upon a count of said second counter during said predetermined period of time; and
receiving a GPS communication signal at said GPS receiver.

29. A wireless communication device comprising:
a first frequency source associated with a GPS receiver and generating a substantially fixed frequency;
a second frequency source associated with a host device and generating an unknown frequency;
a counter coupled to said second frequency source; and
a control circuit coupled to said counter, said control circuit determining the frequency of said second frequency source based upon said substantially fixed frequency and a value of said counter.

30. The apparatus of claim 29 wherein said first frequency source comprises an internal oscillator.

31. The apparatus of claim 30 wherein said internal oscillator comprises a crystal for a real time clock of a GPS receiver.

32. The apparatus of claim 29 wherein said second frequency source comprises an external crystal.

33. The apparatus of claim 29 wherein said control circuit comprises a microprocessor.

34. The apparatus of claim 29 further comprising a memory coupled to said control circuit.

35. A wireless communication device comprising:
an internal oscillator associated with a GPS receiver and generating a known fixed frequency;
a first counter coupled to said internal oscillator;
an external oscillator associated with a host device and generating an unknown frequency;
a second counter coupled to said external oscillator; and
a control circuit coupled to said first counter and said second counter, said control circuit determining the frequency of said unknown frequency.
